(19) United States
(12) Patent Application Publication
(10) Pub. No.: US 2002/0021857 A1
(43) Pub. Date: Feb. 21, 2002

(54) Optical packet switch having optical engine and packet engine

(76) Inventors: Kai Y. Eng, Atlantic Highlands, NJ (US); Jon Anderson, Brielle, NJ (US)

Correspondence Address: KAPLAN & GILMAN , L.L.P., 900NROUTE 9 NORTH, WOODBRIDGE, NJ, 07095, US

(21) Appl. No.: 09/829,565

(22) Filed: Apr. 10, 2001

Related U.S. Application Data
(63) Continuation-in-part of application No. 09/565,727, filed on May 5, 2000.
(60) Provisional application No. 60/234,122, filed on Sep. 21, 2000.
(60) Provisional application No. 60/250,246, filed on Nov. 30, 2000.

(51) Int. Cl. G02B 6/35

(52) U.S. Cl. 385/16; 385/17

(57) ABSTRACT

A method and apparatus for switching optical signals by selectively routing such signals through a packet switch is disclosed. Depending upon predetermined traffic conditions in data being received and transmitted, the system may be provisioned to provide circuit like optical switching, or a mixture of optical and packet switching. An exemplary growable optical switch architecture is disclosed in the preferred embodiment.

### RELATED APPLICATIONS

This application claims the benefit of U.S. Provisional application Ser. No. 60/234,122, filed on Sep. 21, 2000, and also claims the benefit of the U.S. Provisional Application filed on Nov. 30, 2000, entitled “Optical Flow Networking”, Ser. No. 60/250,246, naming Kai Y. Eng as Inventor. Additionally, this application is a continuation-in-part of U.S. application Ser. No. 09/565,727, filed on May 5, 2000, the disclosure of which is incorporated herein in its entirety by this reference.

### TECHNICAL FIELD

This invention relates to telecommunications, and more specifically, to an improved method and apparatus for switching and routing optical signals. The preferred embodiment is also directed to an improved technique of routing optical signals such that efficiency is maximized by subjecting certain signals to packet switching technologies, and routing others in the optical domain without such packet switching.

### BACKGROUND OF THE INVENTION

Optical communications networks are becoming more and more prevalent in order to facilitate high bandwidth long haul connections among communications nodes in a network. One issue not solved by the present state of the art is the provision of full flexibility in routing options at each of plural nodes in a network. More specifically, typically the optical transport systems represent large “pipes” to convey data at relatively high bit rates, such as 2.5 gigabits per second, or even 10 gigabits per second. The actual packet switching at the nodes is performed by a completely separate computer system known as a packet switch or packet engine.

Conventionally, the routing industry is completely separate from the optical switching industry, having different vendors and different technologies. There exists little or no standards for the packet switching modules and the optical systems to interoperate.

The optical portion of long haul communications systems operate by provisioning circuit like connections from specified optical inputs to specified outputs. This provisioning is conventionally accomplished independent of, and without knowledge of, any configuration or provisioning of the packet switching portions of the network.

Conversely, the packet switching portions of the networks operate by reading addresses in the packet headers, and routing the packets based thereon. However, the packet switching operations are far slower than that of the circuit like optical switching. Moreover, the packet switching operates independently of the circuit switching, and thus, there exists no way to optimize the routing algorithms utilized by the packet switch.

Additionally, numerous other inefficiencies exist due to the total separation of the optics from the packet switching. For example, there is no way of taking advantage of the fact that certain switching needs may be based more upon optical switching requirements or packet switching requirements. There exists no known technique of taking immediate advantage of changes in the optical topology of the network in setting up packet routing algorithms, since the packet routing algorithms have no knowledge of the optical topology of the network, or of changes in such topology. Similarly, the packet routing algorithms operate to maximize efficiency without accounting for the topology of the optical network and its changes, thereby precluding optimum performance.

In view of the above, there exists a need in the art for an improved technique of switching signals routed through a data network using optical media and optical switches, as well as packet switches.

### SUMMARY OF THE INVENTION

The above and other problems of the prior art are overcome and a technical advance is achieved in accordance with the teachings of the present invention. An optical engine and a packet engine are interconnected in a manner such that incoming optical signals may be switched directly out through the optical engine or processed through the packet engine, depending upon requirements needed to maximize switching efficiency.

In one exemplary embodiment, an optical engine and a packet switching engine are employed and interconnected. Packets arriving to the packet engine may be switched out of the packet engine or out of the optical engine, and packets arriving in the optical engine may be switched out of the optical engine or out of the packet engine. Additionally, packets arriving in the optical engine may be switched through the packet engine and back out the optical engine.

In a particular preferred embodiment, three switching modules are used to construct the optical switches in a manner that provides add and drop capability using a modular architecture. This preferred architecture allows a relatively large switch to be built from relatively small components. It also permits the provisioning of a packet switch to be done in a manner that accounts for the static and dynamic properties of the optical network. The architecture allows the full integration of the optical switching portion of a node with the packet switching portion of a node.

The foregoing and other advantages and features of the present invention will become clearer upon review of the following drawings and detailed description of the preferred embodiments.

### BRIEF DESCRIPTION OF THE DRAWINGS

FIG. 1 shows a high level functional diagram of a combination of optical engine packet engine node in accordance with the present invention;

FIG. 2 shows a slightly more detailed diagram of the optical engine utilizing multi-channel DWDM inputs and outputs;

FIG. 3 shows an additional embodiment of the invention utilizing signal channels inputs and outputs;

FIG. 4 depicts a conceptual diagram of the interconnection of the packet engine and optical engine;

FIG. 5 depicts a modularly built optical switching architecture; and

FIG. 6 depicts one of the modules of the arrangement of FIG. 5.

### DETAILED DESCRIPTION OF THE PREFERRED EMBODIMENT

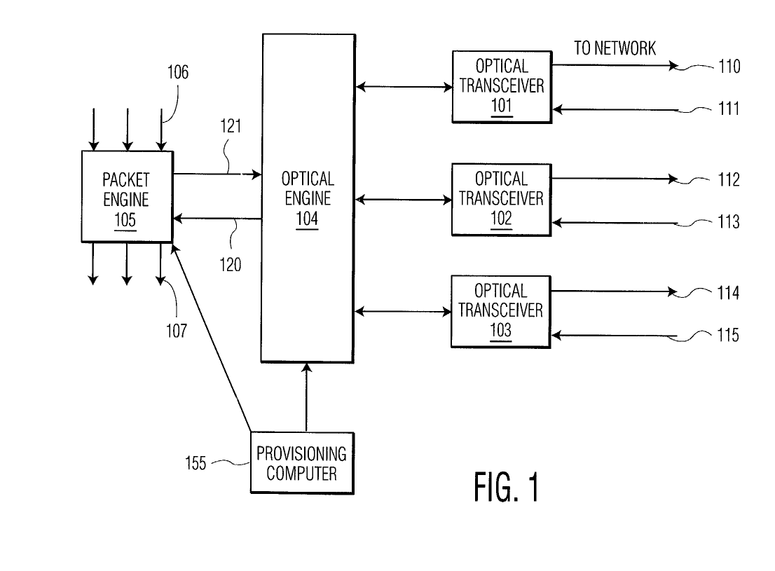

FIG. 1 depicts a functional block diagram of an exemplary embodiment of the present invention. The arrangement of FIG. 1 includes plural optical transceivers 101-103, an optical engine 104 and a packet switching engine, or simply a packet engine, 105. Inputs and outputs 106 and 107, respectively, connect packet engine 105 to the two other nodes of a packet switching network that also perform packet switching. Optical engine 104 takes inputs and provides outputs from and to an optical network as indicated by input/output lines (“I/O”) 110-115.

A provisioning computer 120 is connected to both a packet engine 105 and optical engine 104 in order to provide provisioning for both the packet engine and optical engine. Notably, the preferred embodiment uses the same provisioning computer, and even the same software, for setting up and provisioning the optical portions of the network, as well as for the packet switching portions of the network. By having a common provisioning computer and/or software, the provisioning can be done in a manner that optimizes each of the optical and packet engine's provisioning.

The computer 155 provisions the optical engine 104 and packet engine 105 by setting and/or resetting switching that cause inputs to be directed to prescribed outputs. In the case of the optical engine 104, for example, the provisioning may cause mirrors to either activate or deactivate. In the case of the packet engine 105, the provisioning is arranged to cause outputs destined for a specified “next hop” in the packet network to exit the packet engine out of a specified output. The setting and resetting of switches as part of the provisioning is known to those of skill in the art and will not be discussed in great detail herein.

As is known to those of skill in the art, the optical engine typically operates as a cross connect, accepting data on one or more inputs at one or more wavelengths, and transmitting such data out of 1 or more outputs on the same or different wavelength. Thus, for example, optical engine 104 may comprise input wavelengths 1-3, output wavelengths 4-6, and a switching matrix that can take each input and transmit it out onto a different output. Typically, optical engine 104 may also reshape and regenerate the optical signals so that any degradation due to transmission and switching is removed. Thus, the optical signals exiting from the optical engine are “clean”, i.e. with very high signal to noise ratios.

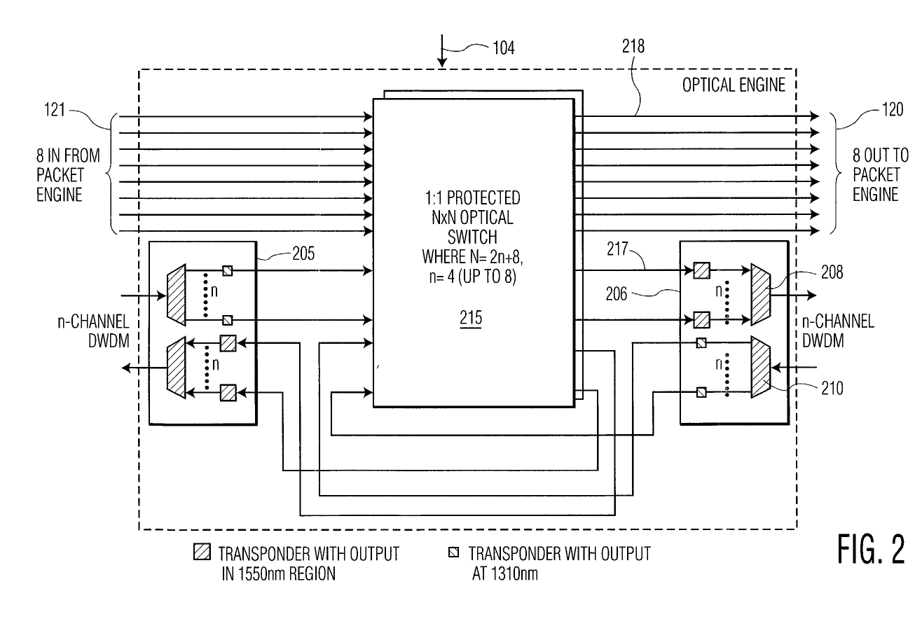

FIG. 2 depicts a block diagram of optical engine 104 of FIG. 1. FIG. 2 intended to be an exemplary embodiment showing one implementation of the concepts described herein, and is not intended to limit the scope of the present invention. Many of the subcomponents of the system are readily available and known to those of skill in the art, and thus, they will not be described in great detail hereafter.

Optical engine 104 is connected to the packet engine 105 of FIG. 1 through lines 121 and 120 as shown in FIGS. 1 and 2. Each of the lines 120-121 may actually be plural lines, as indicated in FIG. 1. Lines 120 and 121 facilitate the exchange of data between packet engine 105 and optical engine 104. The optical engine comprises optical multiplexors 205 and 206 for receiving and transmitting data to and from an optical transport network. Each transceiver comprises a multiplexing portion 208 for receiving information from plural channels and transmits the information as one optical signal in the 1550 nanometer (nm) region. Conversely, the receiving portion includes a demultiplexer 210, which demultiplexes signals received in the 1550 nm range as shown, and demultiplexes them into plural outputs. These wavelengths are by way of example, and not limitation.

Notably, the switching matrix 215 may receive as input a signal generated from the receipt of optical signals as well as signals received from the packet engine. The output of switching matrix 215 may be transmitted directly to the optical network such as over line 217, or may be transmitted to the packet engine, such as over line 218.

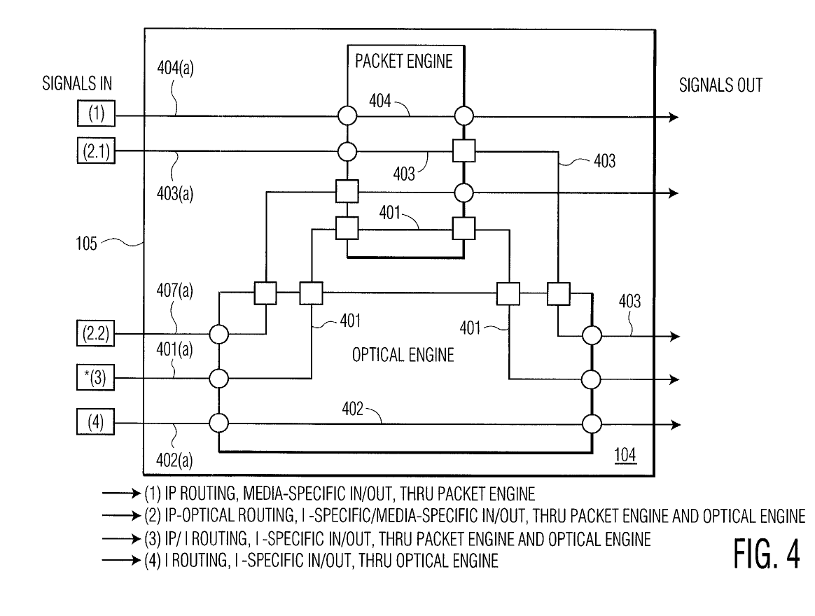

As a result of the foregoing, the system can be viewed conceptually as shown in FIG. 4. As shown therein, inputs may arrive to the optical engine and be transmitted through the packet engine and back out the optical engine, such as indicated by path 401. Other inputs may be received via the optical engine and transmitted directly through the optical engine, without being sent through the packet engine, such as indicated by path 402. Still further inputs may be received via the packet engine and sent out the optical engine, such as indicated by path 403. Finally, inputs may arrive in packet form via the packet engine 105 and be transmitted out of the packet engine such as shown at path 404.

All signals passing from an input to an output of packet engine 105 are routed by examining the packet header and choosing an output to convey the packet to the next packet switch and the packet switching engine, in accordance with any of a variety of well known routing and packet switching algorithms. All signals passing from an input to an output of the optical engine are conveyed in a circuit switching manner from an input to an output, and may exit on a different wavelength than that on which it arrived.

In view of the foregoing, it can be appreciated in various mixtures of packet and circuit switching are made feasible by the techniques of the present invention. For example, returning to FIG. 1, the input to optical transceiver 101 from optical engine 104 may comprise the combination of signals received originally in optical engine 104 from packet engine 105, with signals originally received through optical transceiver 103 from the optical network and routed through packet engine 105. Accordingly, the designer may “mix and match” any of the desired manners of provisioning either the optical engine or the packet engine.

One manner in which this mix and match can be taken advantage of is in the determination of whether to route arriving optical signals through the packet engine 104 or directly back out the optical engine 105. For example, consider an arriving bit stream from the optical network that is conveyed from line 115 of FIG. 1 through optical transceiver 103. If the arrival rate of the data is such that it nearly maximizes the capacity of an inbound and an outbound channel, than greater efficiency can be achieved by avoiding any packet switching. The following example is illustrative.

Suppose that the bit stream represents data arriving at an average rate of 2.4 gb/s, and that the line 115 over which the data arrives is provisioned to be an optical line at 2.5 gb/s. Further, consider a situation wherein all of such 2.4 gb/s of arriving data is to be sent to a specific next node over output line 110. In such a case, it is not worthwhile to send the arriving data through the packet engine 105. This is because nearly all of the capacity of both the inbound link 115 and the outbound link 110 will be used for the single optical provisioned connection. For example, 2.4/2.5, or approximately 96 percent of the capacity of outbound link 110 will be used by the incoming data from line 115. If all of the data incoming from line 115 where sent through the packet engine 105, such procedure could at best cram an additional 4 percent onto the outgoing line 110. However, the benefit of getting an additional four percent may, and likely would, be outweighed by the additional load and latency created as a result of the fact that all data arriving on line 115 would have to be conveyed to and processed by the packet switch.

In accordance with the teachings of the present invention, the provisioning software may be set to recognize when a predetermined percentage of the optical bandwidth of any incoming line is utilized for a specific single optical output. The predetermined percentage maybe set be a user, and can be changed through a simple data input technique such as a graphical user interface. (GUI).

When the user or software recognizes that the percentage of data arriving on a single predetermined input is destined for a single predetermined output, the optical provisioning will be configured to avoid transmitting packets arriving on the input through the packet engine. This optical provisioning could even happen automatically, by providing a capacity monitor for the lines. When the preset condition is recognized, the optical provisioning is changed. Elimination of routing of packets through the packet engine 105 under certain circumstances creates a slight inefficiency in the sense that no further capacity of the outbound line 110 can be used. Thus, it is only filled to 96 percent capacity in the example given. However, reduced latency and increased speed are achieved.

Alternatively, the avoidance of packet switching can be done in advance by the user, rather than automatically be the switching system. More specifically, if the user knows that a certain percentage of the traffic arriving on a particular input is destined for an output, than the system can be provisioned to avoid the packet switching when it is preprovisioned.

Another condition that helps efficiency by avoiding the packet switching is a condition in which most traffic arriving on lines other than the input line 115 is NOT destined from a particular output. When this condition occurs, the packet switching can be avoided even when most of the capacity of an outgoing optical line is NOT used up. Consider for example, a condition wherein it is known in advance that no data from input lines 115 and 113 is destined for output line 110, and that the only data destined for output line 110 comes from input line 111. In such a case, there is no need to transmit data from input line 111 through packet engine 105. Instead, all such data can be optically switched from input line 111 to output line 110, even though the amount of such data may be far less than the capacity of the output line 110. This is because no significant inefficiency occurs due to the fact that even though most of the capacity of output line 110 is not used, the unused capacity would not be used even if the data were routed through packet engine 105. Accordingly, latency is reduced and overall efficiency is increased.

In general then, the technique of the present invention may provision the optical and packet engines, either in advance or during operation thereof, in such a manner that upon a predetermined condition in such traffic, the traffic is switched directly through the optical engine as opposed to through the packet engine. In a preferred embodiment, that predetermined condition includes whether or not a prescribed percentage of such traffic or more from a single input is destined for a particular output, or whether traffic from plural outputs is not destined for a particular output. Other conditions may be utilized as well.

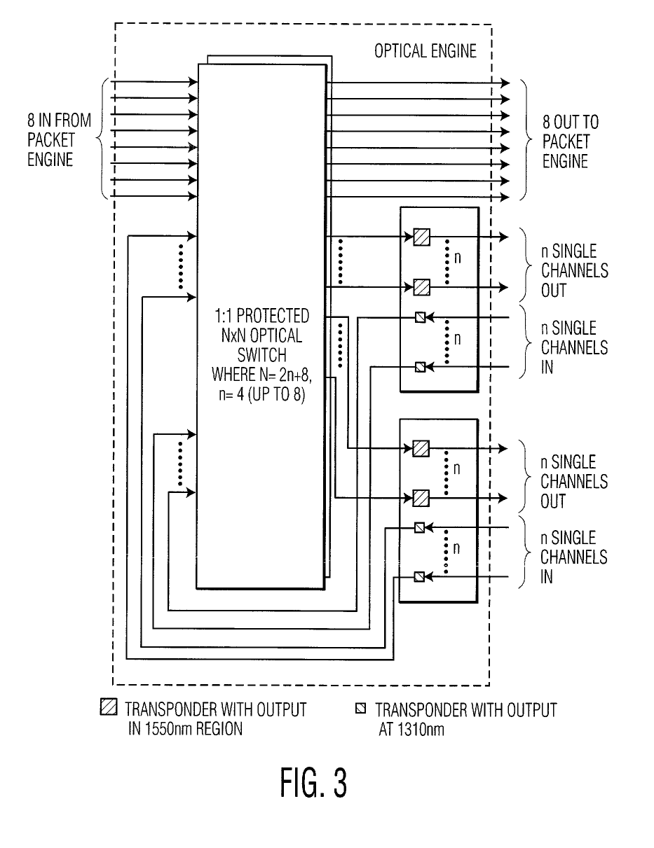

FIG. 3 shows a slightly different embodiment of the present invention wherein the input and output channels are not multiplexed and demultiplexed as shown in FIG. 2. Instead, each of the plurality of inputs and outputs arrives on a separate line and is fed into the optical switching matrix for processing as previously described with respect to FIG. 2.

With regard to the teachings of the present invention, the use of multixplexing and demultiplexing, or the use of separated lines without such multiplexing and demultiplexing, is not critical to the operation of the present invention.

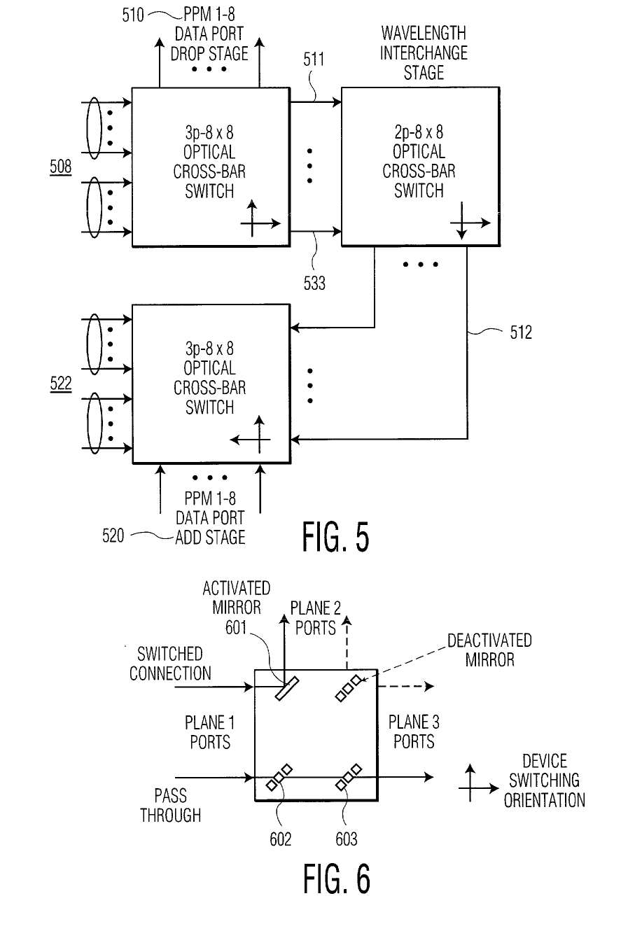

FIG. 5 shows an exemplary implementation for use in a preferred exemplary embodiment, the arrangement of FIG. 5 optical switching arrangement used within the optical engine of the present invention. The three port cross bar switches 501 and 502 are coupled with a two port cross bar switch 503. This creates an optical switching arrangement with 16 inputs and 16 outputs, wherein half of each of the inputs and outputs are to and from the optical network, and remaining half are connected through the packet engine as shown in FIG. 1.

The provisioning of the optical engine includes configuring each of the optical crossbar switches 501-503 to direct desired inputs and outputs as indicated conceptually in FIG. 5. More specifically, referring to crossbar switch 501, the crossbar switch 501 includes 8 inputs and 16 outputs, wherein each of the inputs 501 maybe provisioned for conveying to one of outputs 510 or 511. Crossbar switch 503 has only 2 ports, the 8 inputs arriving on lines 511 being capable of conveyance to any one of outputs 512. Moreover, data arriving at cross bar switch 502 on any of lines 512 or input lines 520 may be conveyed to a desired one of output ports 522.

As a result of the foregoing arrangement, the three crossbar switches 501 through 503 comprise an optical switching arrangement which accepts 8 optical inputs and transmits 8 optical outputs 522. However, the arrangement also accepts 8 inputs from a packet switch and outputs 8 outputs 510 to a packet switch. Thus, the resulting system is an optical switching arrangement which receives 16 inputs 508 and 520, and transmits 16 outputs 510 and 522, with a limitation that portions of the inputs and outputs must be optical or packets as shown. The foregoing architecture not only allows modular growth, but it permits the provisioning of both the optical and packet portions in one integrated application.

FIG. 6 shows the provisioning of the optical switching arrangements of FIG. 5. As indicated in FIG. 6, a mirror 601 may be activated to switch the signal or may be passive such as mirrors 602-603 so that the optical signal passes through. In crossbar switch 503, an input 533 would pass through all mirrors in its path until reaching one which is activated to deflect the signal downward out path 512. Additionally, reference to FIG. 4, can be appreciated at any of the signals arriving may be passed through the optical engine or switched to the packet engine by appropriate provisioning of the optical arrangement via activating and deactivating the desired mirrors.

In accordance with the above technique, larger switches may be grown in a modular fashion from smaller optical switching arrangements. The arrangement shown FIG. 5 maybe arranged in a hierarchy to build larger switches from the same size switching components.

While the above describes the preferred embodiment of the invention, various modifications or additions will be apparent to those of skill in the art. Such modifications and additions are intended to be covered by the following claims.

What is claimed:

1. Optical packet switching apparatus comprising:
An optical engine for switching signals from inputs to outputs depending upon predetermined provisioning;
A packet engine arranged to receive signals from said optical engine and to transmit signals to said optical engine after performing packet switching on said signals; and
A processor for determining, in response to at least one characteristic of traffic to the node, whether signals input to said optical engine should be switched directly to an output of said optical engine or first routed through said packet engine prior to being switched to an output of the optical engine.

2. Apparatus of claim 1 wherein said characteristic includes the percentage of total capacity of an optical input to said node that is to be switched to a single optical output of said node.

3. Apparatus of claim 1 wherein said characteristic is whether or not at least one inpute does not have any traffic destined for a predetermined output.

4. Apparatus of claim 1 wherein said packet engine is arranged to receive data from both said optical engine and from a packet network.

5. Apparatus of claim 1 wherein said packet engine and said optical engine are both connected to a single provisioning computer.

6. Apparatus of claim 1 wherein said optical engine comprises at least one multiplexer and at least one demulitplexer.

7. Apparatus of claim 1 wherein said packet engine is configured to receive plural inputs from a non optical packet network and plural inputs from said optical engine, and said optical engine is configured to receive plural inputs from an optical network and plural inputs from said packet engine.

8. An optical and packet switching device comprising plural optical inputs, plural packet inputs, plural optical outputs, and plural packet outputs, each optical input having a capacity, each of said optical inputs being selectively routed to either an optical output not connected to a packet input, or an optical output connected to a packet input, depending upon the percentage of the capacity of said optical input utilized.

9. The device of claim 8 wherein each of said optical inputs is connected to a multiplexer.

10. The device of claim 9 wherein said optical engine comprises at least one two port device and at least one three port device.

11. An optical switching device having first, second, and third cross bar switches, said first cross bar switch having first inputs, second outputs, and third outputs, said second cross bar switch having fourth inputs and fifth outputs, said third cross bar switch having sixth and seventh inputs and eighth outputs, said third outputs being connected to said fourth inputs, said fifth outputs being connected to said sixth inputs, said first inputs and eight outputs being connected to an optical network.

12. The device of claim 11 wherein said seventh inputs and said second outputs are connected to a packet switching network.

13. The device of claim 12 wherein said first inputs and said eight outputs are connected to an optical network.

14. The device of claim 11 wherein said cross bar switches are provisioned by activating and deactivating specified mirrors therewithin.

15. A method of provisioning a node comprising optical switching and non optical switching portions, said method comprising the steps of ascertaining loading on the node caused by at least one optical input, and determining whether or not to switch said optical input through said nonoptical switching portion depending upon whether or not said optical input presents at least a predetermined load on said node.

16. The method of claim 15 wherein said predetermined load is measured by calculating a capacity associated with an optical input, and determining what percentage of said capacity represents data arriving on said optical input and destined for a single optical output.

17. An optical switch comprising a first cross bar switch configured to receive information on plural inputs from a second cross bar switch, and to transmit outputs to a third cross bar switch, the second cross bar switch having the same number of inputs and outputs, and the first and third cross bar switches having different numbers of inputs and outputs.

18. The optical switch of claim 17 wherein the first cross bar switch has more outputs than inputs, the third cross bar switch has more inputs than outputs, and the second cross bar switch has as many inputs as outputs.

19. The optical switch of claim 18 wherein some inputs to the third cross bar switch are configured to receive data from the second cross bar switch, and some inputs are configured to receive data from a packet switch.

20. The optical switch of claim 19 wherein some inputs of the first crossbar switch are configured to transmit data to a packet switch, and some outputs of said first cross bar switch are configured to transmit data to said second cross bar switch.
